(19) United States
(12) Patent Application Publication
(10) Pub. No.: US 2012/0166606 A1
(43) Pub. Date: Jun. 28, 2012

(54) DISTRIBUTED FILE OPERATION APPARATUS, DISTRIBUTED FILE OPERATION METHOD, AND NON-TRANSITORY COMPUTER-READABLE MEDIUM STORING DISTRIBUTED FILE OPERATION PROGRAM

(75) Inventors: Takeshi MIYAMAE, Kawasaki (JP); Kensuke Shiozawa, Kawasaki (JP)

(73) Assignee: Fujitsu Limited, Kawasaki (JP)

(21) Appl. No.: 13/280,908

(22) Filed: Oct. 25, 2011

(30) Foreign Application Priority Data
Dec. 24, 2010 (JP) 2010-288358

(51) Int. Cl. G06F 15/173

(52) U.S. Cl. 709/223

(57) ABSTRACT

A distributed file operation method is executed by a computer that is connected to an arrangement information management apparatus and a plurality of file management apparatuses through a network. The arrangement information management apparatus is configured to manage arrangement information of files. The plurality of file management apparatuses is configured to store the files. The distributed file operation method includes generating an operating request on a first file on the basis of a first protocol, making, by the computer, an inquiry to the arrangement information management apparatus on arrangement information of the first file by specifying an identifier of the first file, and transmitting the operating request to one of the plurality of file management apparatuses indicated by the arrangement information that is provided in response to the inquiry by the arrangement information management apparatus.

### CROSS-REFERENCE TO RELATED APPLICATION

This application is based upon and claims the benefit of priority of the prior Japanese Patent Applications No. 2010-288358, filed on Dec. 24, 2010, the entire contents of which are incorporated herein by reference.

### FIELD

The embodiments disclosed herein relate to a distributed file operation apparatus, a distributed file operation method, and a distributed file operation program.

### BACKGROUND

NAS (Network Attached Storage) is a file server dedicated apparatus which can be used by being directly connected to a network. A client of the NAS can use a file data storage area in the NAS (in the server) as if the storage area were included therein. In general, one server (a NAS server) that serves as the NAS corresponds to a storage (a NAS client) which is virtualized in the client on a one-to-one basis. As an example of the storage which is virtualized in the client, a drive in Windows (registered trademark) may be given. Therefore, the expression “a NAS server corresponds to a virtualized storage on a one-to-one basis” indicates that, for example, one server is allocated to one drive.

However, a configuration in which a NAS client corresponds to a NAS server on a one-to-one basis lacks scalability. Therefore, a technique for scaling out the NAS server (Scale-out NAS) has been hitherto proposed. The Scale-out NAS allows one NAS client to access a plurality of NAS servers.

Japanese Laid-open Patent Publication No. 2004-46661 is an example of related art.

However, in the Scale-out NAS, a process of storing file data by distributing it to a plurality of NAS servers in units of files is incorporated into the kernel of an OS (Operating System) of a NAS client. Therefore, it is difficult for a third person to implement, in NAS clients that use a non-open source OS (e.g., Windows (registered trademark)), a function for coping with distributed management of files performed by a plurality of NAS servers. Here, the third person indicates a person who is unauthorized to change source code of an OS, such as, for example, a person other than a holder of the source code of the OS.

### SUMMARY

According to an aspect of the embodiments, a distributed file operation method is executed by a computer that is connected to an arrangement information management apparatus and a plurality of file management apparatuses through a network. The arrangement information management apparatus is configured to manage arrangement information of files. The plurality of file management apparatuses is configured to store the files. The distributed file operation method includes generating an operating request on a first file on the basis of a first protocol, making, by the computer, an inquiry to the arrangement information management apparatus on arrangement information of the first file by specifying an identifier of the first file, and transmitting the operating request to one of the plurality of file management apparatuses indicated by the arrangement information that is provided in response to the inquiry by the arrangement information management apparatus.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a file management system according to an embodiment.

FIG. 2 is a diagram illustrating an example of a hardware configuration of a client apparatus according to an embodiment.

FIG. 3 is a diagram illustrating an example of a functional configuration of a file management system according to an embodiment.

FIG. 4 is a flowchart illustrating an example of procedures of a process that a filter unit executes in transmission of a file operating request.

FIG. 5 is a diagram illustrating an example of a data structure in an arrangement information storage unit.

FIG. 6 is a flowchart illustrating an example of procedures of a process that a client apparatus executes in response to reception of a READ response message.

FIG. 7A and FIG. 7B are diagrams illustrating examples of a structure of an OSD-protocol-based READ response message and a structure of a CIFS-protocol-based READ response message.

FIG. 8A and FIG. 8B are diagrams illustrating examples of copying of a header part of a CIFS-based READ response message by writing it over an OSD-based READ response message.

FIG. 9A and FIG. 9B are diagrams illustrating an example of data processing executed when writing of the header part of a CIFS-based READ response message over an OSD-based READ response message is not allowed.

FIG. 10 is a diagram illustrating an example of a configuration of a client apparatus that an embodiment is applied to a specific implementing system.

### DESCRIPTION OF EMBODIMENTS

Embodiments will be described with reference to the accompanying drawings.

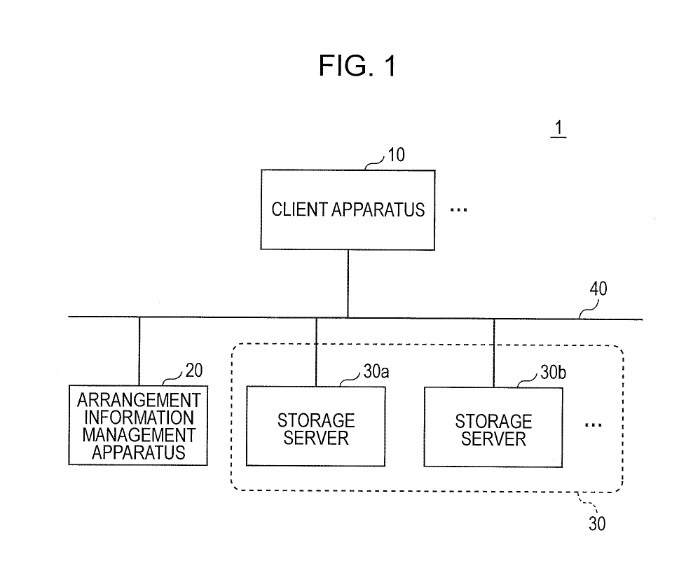

FIG. 1 is a diagram illustrating an example of a configuration of a file management system according to an embodiment. In the figure, a file management system 1 includes a client apparatus 10, an arrangement information management apparatus 20, and a plurality of storage servers 30. It is supposed that each apparatus included in the file management system 1 can communicate with one another over a network 40 (wired or radio) such as a LAN (Local Area Network) or the Internet. In addition, a plurality of client apparatuses 10 and/or a plurality of arrangement information management apparatuses 20 may be included in the file management system 1.

The storage server 30 is a so-called NAS (Network Attached Storage) server and is an apparatus that stores (manages) a group of files that hold data. In the embodiment, the plurality of storage servers 30 manage a plurality of files in a distributed fashion. That is, the storage server 30 is an example of a file management apparatus in the embodiment. In the embodiment, it is supposed that the storage server 30 is an OSD (Object-based Storage Device) server for convenience. The OSD server is a server that provides an object-based interface for a file that it manages. Thus, communication with the storage server 30 for file operation is made on the basis of the OSD protocol.

The arrangement information management apparatus 20 is an apparatus that stores arrangement information of each file that the plurality of storage servers 30 manage in a distributed fashion. The arrangement information is information indicating a location at which each file is arranged. That is, the arrangement information management apparatus 20 manages information indicating that each file is arranged in which storage server 30. In the embodiment, it is supposed that the arrangement information management apparatus 20 is a CIFS (Common Internet File System) server, for convenience. That is, communication with the arrangement information management apparatus 20 is made on the basis of the CIFS protocol. The CIFS protocol is an example of a first protocol in the embodiment.

The client apparatus 10 is a so-called NAS client. That is, the client apparatus 10 is a computer that serves as an operation source of files that the storage servers 30 manage. The client apparatus 10 is an example of a distributed file operation apparatus in the embodiment.

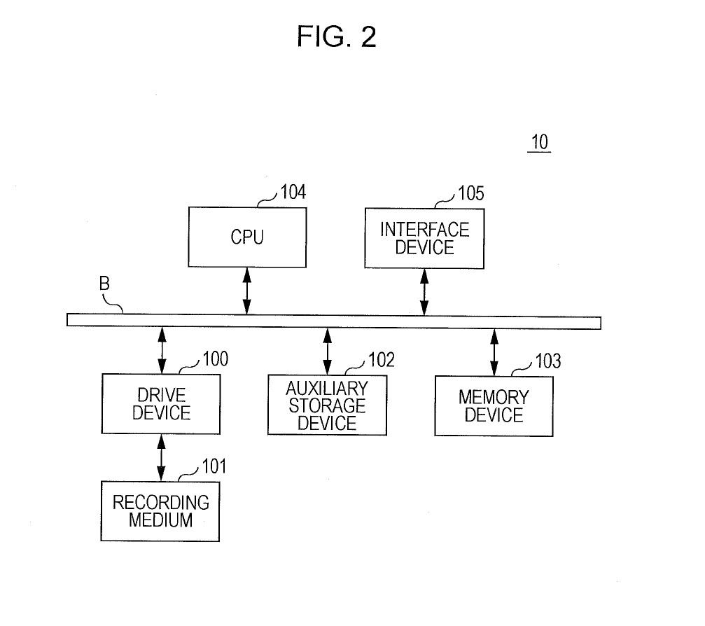

FIG. 2 is a diagram illustrating an example of a configuration of hardware of a client apparatus in the embodiment. In FIG. 2, the client apparatus 10 includes a drive device 100, an auxiliary storage device 102, a memory device 103, a CPU 104, and an interface device 105 which are connected to one another via a bus B.

A program that implements a process to be executed in the client apparatus 10 is provided by a recording medium 101. When the recording medium 101 storing the program is set in the drive device 100, the program is installed from the recording medium 101 into the auxiliary storage device 102 via the drive device 100. The program is not necessarily installed from the recording medium 101 and may be downloaded from another computer over a network. The auxiliary storage device 102 stores the installed program and also stores desired files and data.

In response to a program start instruction, a program is read out from the auxiliary storage device 102 and stored in the memory device 103. The CPU 104 executes functions of the client apparatus 10 in accordance with the program stored in the memory device 103. The interface device 105 is used as an interface for connection to a network.

Portable recording media such as a CD-ROM, a DVD, and a USB memory may be given as examples of the recording medium 101. In addition, an HDD (Hard Disk Drive), a flash memory and the like may be given as examples of the auxiliary storage device 102. Each of the recording medium 101 and the auxiliary storage device 102 corresponds to a computer-readable recording medium.

In addition, when the client apparatus 10 is operated directly by a user, the client apparatus 10 may include input devices such as a keyboard and a mouse, and display devices such as a liquid crystal display. In addition, the arrangement information management apparatus 20 and the storage server 30 may have hardware configurations which are the same as that illustrated in FIG. 2.

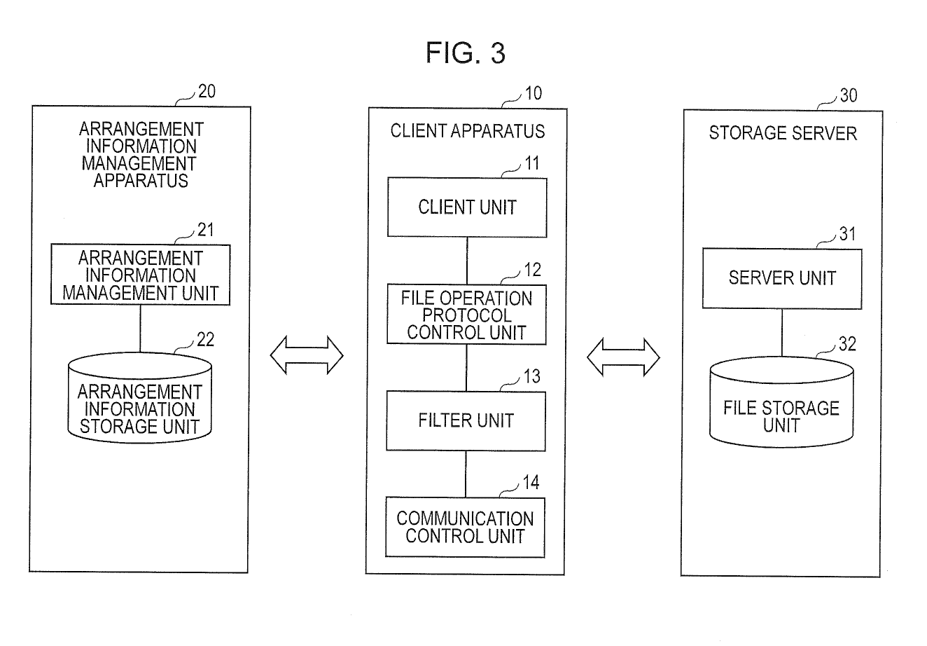

FIG. 3 is a diagram illustrating an example of a functional configuration of a file management system according to an embodiment.

In FIG. 3, the storage server 30 includes a server unit 31 and a file storage unit 32. The file storage unit 32 stores an entity of a file using an auxiliary storage device of the storage server 30. The server unit 31 receives a file operating request from the client apparatus 10 in accordance with the OSD protocol. The server unit 31 executes a process relevant to the file operating request on a file that the file storage unit 32 stores, and returns a response including a result of the process to the client apparatus 10 in accordance with the OSD protocol. The OSD protocol is an example of a second protocol in the embodiment.

The arrangement information management apparatus 20 includes an arrangement information management unit 21 and an arrangement information storage unit 22. The arrangement information storage unit 22 stores arrangement information of each file which is managed in the plurality of storage servers 30 in a distributed fashion, using an auxiliary storage device of the arrangement information management apparatus 20. The arrangement information management unit 21 receives a request for acquiring arrangement information of a file subjected to file operation and acquires the arrangement information of the file from the arrangement information storage unit 22. The arrangement information management unit 21 returns the acquired arrangement information to the client apparatus 10.

The client apparatus 10 includes a client unit 11, a file operation protocol control unit 12, a filter unit 13, and a communication control unit 14. These units are implemented by processes that a program, which is installed in the client apparatus 10, causes the CPU 104 to execute. Each unit is not necessarily implemented by one program. For example, in this embodiment, the filter unit 13 is implemented by another program which is prepared independently of programs for other units. Another program is an example of a distributed file operation program.

The client unit 11 is software (for example, an application program) which serves as a source of a file operating request. In response to a file operating instruction which is, for example, input via an input device or received over a network, the client unit 11 inputs a file operating request that corresponds to the file operating instruction into the file operation protocol control unit 12. The operating request is input into the file operation protocol control unit 12 via an interface (for example, a group of functions) that the file operation protocol control unit 12 provides.

The file operation protocol control unit 12 generates a CIFS-protocol-based request message (hereinafter, referred to as a “CIFS request message”) that corresponds to the file operating request which has been input from the client unit 11. That is, the file operation protocol control unit 12 generates a request for operating a certain file that the storage servers 30 manage on the basis of the CIFS protocol. The file operation protocol control unit 12 is an example of a first control unit in the embodiment.

The communication control unit 14 controls communication, performed by the client apparatus 10 over the network 40, using the interface device 105. The communication control unit 14 controls communication based on a communication protocol in a layer that is lower than that of the CIFS protocol. The expression “the layer that is lower than that of the CIFS protocol” is based on a vertical relationship between layers in the OSI reference model, for example. For example, the communication control unit 14 accepts a communication request and performs other operations via a TDI (transport driver interface). The TDI is a common interface between the transport layer and the session layer and serves to absorb a difference of the transport layer.

In general, a CIFS request message generated by the file operation protocol control unit 12 is input into the communication control unit 14 and is then output from the communication control unit 14. Upon receiving a response message for the CIFS request message, the communication control unit 14 notifies the file operation protocol control unit 12 of the response message.

Here, the expression “in general” indicates a situation where the filter unit 13 is not present. However, the filter unit 13 is present in this embodiment. Thus, control which is different from the control which is performed “in general” is performed by the filter unit 13. That is, the filter unit 13 snatches up (intercepts) a communication request input into the communication control unit 14. Therefore, the CIFS request message which is output from the file operation protocol control unit 12 is also intercepted by the filter unit 13. The filter unit 13 makes an inquiry to the arrangement information management apparatus 20 about arrangement information of a file subjected to file operation in the intercepted CIFS request message. The filter unit 13 transmits (transfers) the request for operating the file to the storage server 30 indicated by the arrangement information which is returned from the arrangement information management apparatus 20. The storage server 30 supports the OSD protocol. Therefore, the filter unit 13 also converts a CIFS request message to an OSD-protocol-based operating request (hereinafter, referred to as an “OSD request message”). The converted OSD request message is transmitted by the communication control unit 14. The communication control unit 14 is an example of a third control unit in the embodiment.

The filter unit 13 also converts a format of a received response message. The filter unit 13 copes with distributed management of files that the plurality of storage servers 30 perform as described above. In other words, the file operation protocol control unit 12 does not take part in distributed management of files (that is, arrangement of files) because the file operation protocol control unit 12 is implemented on the assumption that the number of corresponding servers is one. The CIFS server is the arrangement information management apparatus 20 in this embodiment. Therefore, the file operation protocol control unit 12 executes processing on the assumption that the files are managed in the arrangement information management apparatus 20. However, in this embodiment, the arrangement information management apparatus 20 is used for management of the arrangement information of each file and is not used for management of the entity of each file.

It is desirable to implement the filter unit 13 in the client apparatus 10 in a dynamically addable fashion. The dynamically addable fashion is a fashion that the filter unit 13 can be added without modifying source code of an existing part (for example, the kernel of the OS of the client apparatus 10, such as the file operation protocol control unit 12 and the communication control unit 14). For example, Windows (registered trademark) provides a mechanism called a filter driver. Therefore, the filter unit 13 may be implemented as the filter driver for the communication control unit 14. The filter unit 13 is an example of a second control unit in the embodiment.

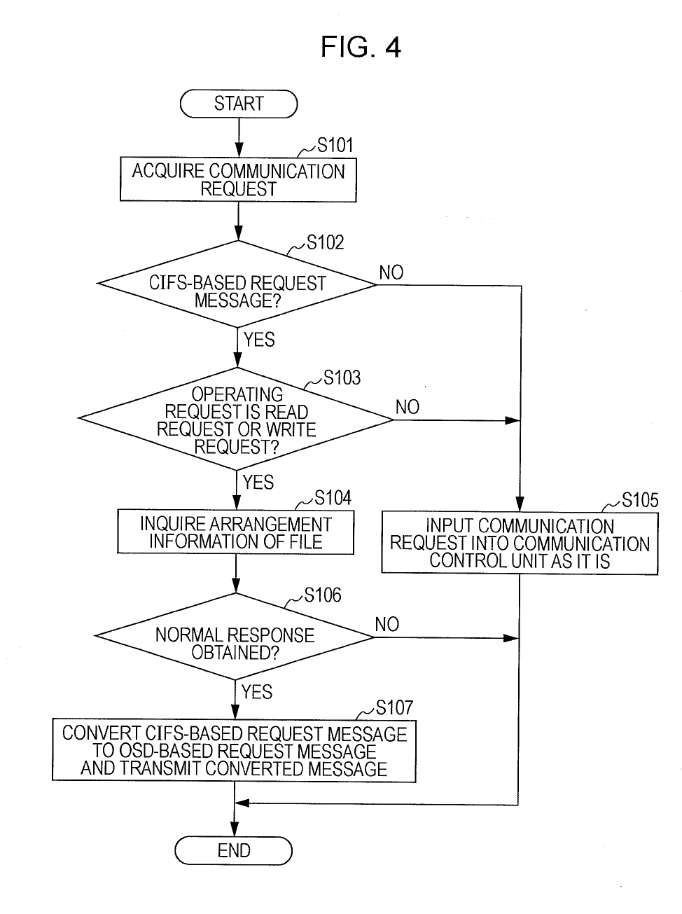

Next, procedures of a process executed by the client apparatus 10 will be described. FIG. 4 is a flowchart illustrating an example of procedures of a process that the filter unit executes in transmission of a file operating request.

For example, once a certain communication request is input into the communication control unit 14, the filter unit 13 intercepts the communication request (S101). Thus, a CIFS request message input into the communication control unit 14 by the file operation protocol control unit 12 is also intercepted by the filter unit 13. Then, the filter unit 13 determines whether the intercepted communication request is the CIFS request message (S102). The determination may be made based on whether a predetermined part of the communication request is of the CIFS-protocol-based format. When the communication request is not the CIFS request message (No at S102), the filter unit 13 inputs the communication request into the communication control unit 14 as it is (unprocessed) (S105). This case corresponds to a case in which the communication request is from a not illustrated program module other than the file operation protocol control unit 12. That is, since the communication control unit 14 is shared by a plurality of program modules, a communication request given from a program module other than the file operation protocol control unit 12 is also input into the communication control unit 14.

On the other hand, when the communication request is the CIFS request message (Yes at S102), it is determined whether a file operating request indicated by the CIFS request message is a READ (reading) request or a WRITE (writing) request (S103). When the file operating request is not the READ request or the WRITE request (No at S103), the filter unit 13 inputs the CIFS request message into the communication control unit 14 as it is (S105). Thus, the CIFS request message is transmitted to the arrangement information management apparatus 20 which is the CIFS server. The arrangement information management unit 21 of the arrangement information management apparatus 20 executes a process corresponding to the CIFS request message and returns a response including a result of execution of the process to the client apparatus 10. For example, if the CIFS request message indicates a request for opening a certain file, the arrangement information management unit 21 executes a process of opening the file and returns a response including an identifier of the file (the file ID) to the client apparatus 10. Therefore, it may be sufficient for the arrangement information management apparatus 20 to store information about a correspondence between a file ID and a file name specified by the file opening request. Or, it may be sufficient to implement a mechanism which allows the arrangement information management apparatus 20 to derive the file ID on the basis of the file name in the file management system 1. The file ID is an ID which is used to identify a file on the basis of the CIFS protocol. The response is received by the communication control unit 14 and the file operation protocol control unit 12 is then notified of the response via the filter unit 13. The file operation protocol control unit 12 returns a return value conforming to the response to the client unit 11.

Since a concept that a file is opened is not present in the OSD protocol, the file opening request is transferred to the arrangement information management apparatus 20 in this embodiment. Therefore, when the storage server 30 which is configured on the basis of a protocol having the concept that a file is opened is used, the file opening request may be transferred to the storage server 30 like the file READ request or the file WRITE request.

On the other hand, when the file operating request that the CIFS request message indicates is the READ request or the WRITE request (Yes at S103), the filter unit 13 makes an inquiry to the arrangement information management apparatus 20 about the arrangement information of a file subjected to file operation in the file operating request indicated by the CIFS request message (S104). That is, the filter unit 13 transmits a request for acquiring arrangement information to the arrangement information management apparatus 20. The file ID of the file subjected to the file operation in the file operating request indicated by the CIFS request message is specified in the acquiring request. The file ID is an ID which is used to identify the file concerned on the basis of the CIFS protocol and is included in the CIFS request message. Incidentally, identification information (IP address and the like) of the arrangement information management apparatus 20 may be recorded in advance in the auxiliary storage device 102 of the client apparatus 10.

When the arrangement information management apparatus 20 receives the arrangement information acquiring request, the arrangement information management unit 21 acquires the arrangement information corresponding to the file ID specified in the acquiring request from the arrangement information storage unit 22 and returns a response including the acquired arrangement information to the filter unit 13.

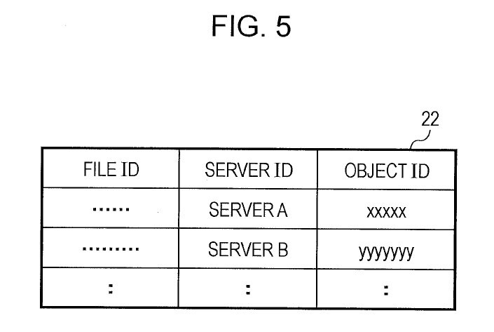

FIG. 5 is a diagram illustrating an example of a data structure in the arrangement information storage unit 22. As illustrated in FIG. 5, file IDs, server IDs, object IDs and the like of respective files are stored in the arrangement information storage unit 22 in units of files which are managed in a distributed fashion.

The file ID is the CIFS-protocol-based file ID as described above. The server ID and the object ID are examples of arrangement information in the embodiment. That is, the server ID is an identifier of each storage server 30. The server ID may be either an IP address of each storage server 30 or an identifier other than the IP address. In the latter case, it may be sufficient for the arrangement information storage apparatus 20 or the client apparatus 10 to store information about a correspondence between the server ID and the IP address. The object ID is an identifier used to identify each file in the storage server 30. Since the storage server 30 handles each file as an object, the identifier of each file is called the object ID in the embodiment.

Therefore, the arrangement information management unit 21 according to the embodiment returns a response including the server ID and the object ID to the client apparatus 10.

When a normal response is returned to the client apparatus 10 from the arrangement information management apparatus 20 in response to the arrangement information acquiring request (Yes at S106), the filter unit 13 converts the CIFS request message to an OSD request message and transmits the OSD request message (S107). The normal response is a response including arrangement information. The transmission destination of the OSD request message is the storage server 30 relevant to the server ID included in the acquired arrangement information.

Conversion from the CIFS request message to the OSD request message and transmission of the OSD request message are performed in the following manner. When the CIFS request message is the READ request, a header part of the OSD request message is generated on the basis of the contents of a header part of the CIFS request message. The filter unit 13 inputs the header part concerned into the communication control unit 14. The communication control unit 14 transmits the header part concerned to the corresponding storage server 30. Incidentally, a data part is not present in the CIFS request message when the message is the READ request. Therefore, the header part constitutes the entire OSD request message. The object ID included in the acquired arrangement information is specified in the header part of the OSD request message as the identifier of the file subjected to file operation.

The server unit 31 of the storage server 30 that has received the OSD request message indicating the READ request reads data from the file corresponding to the object ID specified in the OSD request message. The server unit 31 returns a response message (hereinafter, referred to as a “READ response message”) that includes the read data in its data part to the client apparatus 10 on the basis of the OSD protocol.

On the other hand, when the CIFS request message is the WRITE request, first, the header part of the OSD request message is generated on the basis of the contents of the header part of the CIFS request message. The filter unit 13 inputs the header part into the communication control unit 14. The communication control unit 14 transmits the header part to the corresponding storage server 30. Incidentally, the object ID included in the acquired arrangement information is specified in the header part of the OSD request message as the identifier of the file subjected to operation. When the size of the header part of the CIFS request message is larger than or equal to that of the header part of the OSD request message, the header part of the OSD request message may be written over the header part of the CIFS request message in the same manner as that in reception of a READ response message which will be described later. In this case, the necessity of preparing a new buffer area (a memory area) for the header part of the OSD request message and of executing memory copying may be eliminated.

The data part is present in the CIFS request message when the message is the WRITE request. The data part is a part holding data to be written into the file subjected to the writing request. Therefore, the data part is transmitted after transmission of the header part regarding the OSD request message. Here, when the communication control unit 14 uses TCP (Transmission Control Protocol), the interface for data transmission is of the iovec format (the multiple buffer format). Therefore, consideration of a relation (a connection) between the header part and the data part may be eliminated unlike the situation in reception of the READ response message which will be described later. Accordingly, the filter unit 13 inputs the data part included in the CIFS request message into the communication control unit 14 as it is. The communication control unit 14 transmits the data part to the corresponding storage server 30.

The server unit 31 of the storage server 30 that has received the OSD request message indicating the WRITE request writes the data included in the OSD request message into the file corresponding to the object ID which is specified in the OSD request message. The server unit 31 returns a response (hereinafter, referred to as a “WRITE response”) indicating a result of the writing process and the like to the client apparatus 10 on the basis of the OSD protocol.

Next, procedures of a process that the client apparatus 10 executes when a READ response message is returned from the storage server 30 will be described.

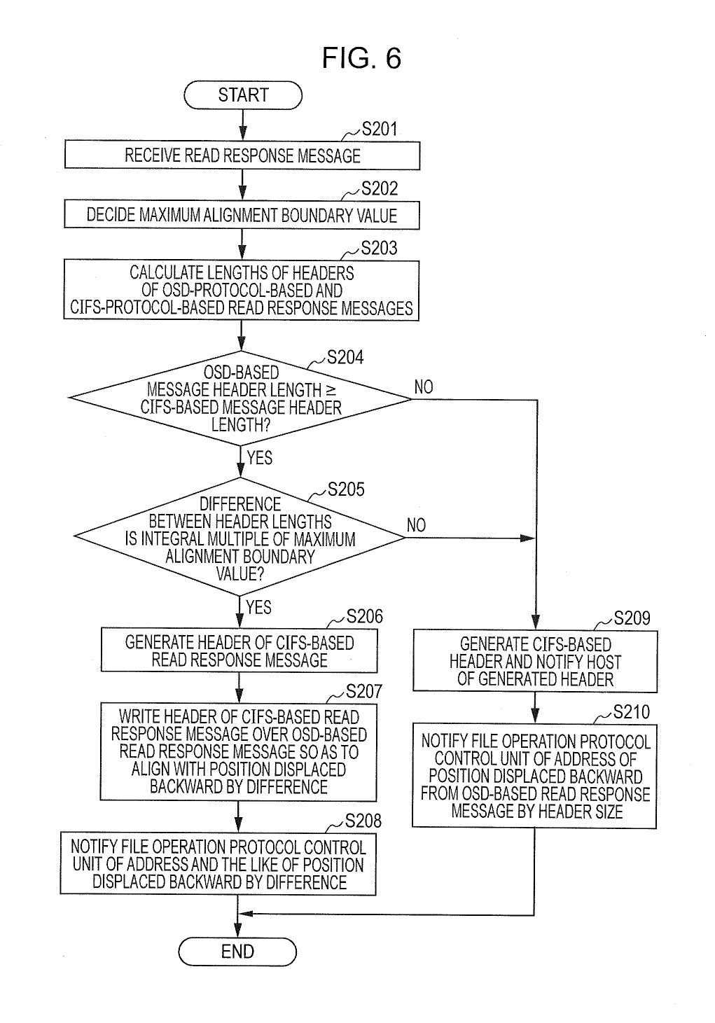

FIG. 6 is a flowchart illustrating an example of procedures of a process that the client apparatus 10 executes in response to reception of the READ response message.

When the communication control unit 14 receives the READ response message, the filter unit 13 is notified of reception of the READ response message (S201). In more detail, the communication control unit 14 generates an event in response to reception of data (for example, the READ response message). An event handler of the filter unit 13 detects reception of the data on the basis of the generated event. Here, the READ response message includes the OSD-protocol-based header part and data part. The filter unit 13 is notified of a starting address of a buffer (hereinafter, referred to as a “receive buffer”) that stores the READ response message and a size of the receive buffer by the event generated from the communication control unit 14.

Then, the filter unit 13 determines a maximum alignment boundary value of a memory address relevant to a process of notifying the file operation protocol control unit 12 of the READ response message (S202). In the embodiment, alignment indicates to perform adjustment such that when data or the like is to be stored into a memory area, the starting address of the data has a regularized value. For example, the starting address is aligned to have an even number or is aligned on an N-byte boundary. Examples of the alignment of the memory address relevant to the process of notifying the file operation protocol control unit 12 of the READ response message include alignment relevant to memory copying and alignment of a READ buffer of the file operation protocol control unit 12. A maximum boundary value of various alignment operations as mentioned above is determined at step S202. For example, when the boundary value of the alignment relevant to memory copying is four bytes and the boundary value of the alignment of the READ buffer of the file operation protocol control unit 12 is eight bytes, the maximum value is eight bytes.

Incidentally, the boundary value of each alignment may be dynamically acquired at step S202, for example, in a system environment in which the boundary value may be dynamically acquired using an OS or the like. In a system environment in which the boundary value may not be dynamically acquired, a fixed value which is calculated and stored in advance in the auxiliary storage device 102 may be acquired as the boundary value at step S202.

Then, the filter unit 13 calculates a size (header length) of the header part of the received OSD-protocol-based READ response message. The filter unit 13 also calculates a size of the CIFS-protocol-based READ response message which is to be generated (S203).

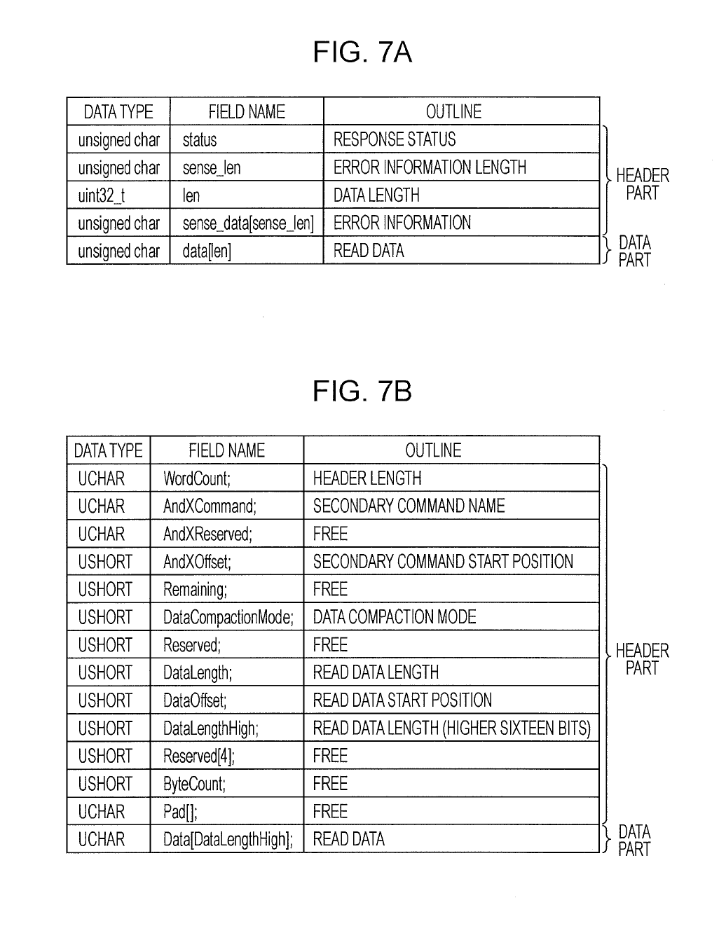

FIG. 7A and FIG. 7B are diagrams illustrating examples of a structure of an OSD-protocol-based READ response message and a structure of a CIFS-protocol-based READ response message. FIG. 7A illustrates an example of a structure of an OSD-protocol-based READ response message (hereinafter, referred to as an “OSD-based READ response message”) and FIG. 7B illustrates an example of a structure of a CIFS-protocol-based READ response message (hereinafter, referred to as a “CIFS-based READ response message”). In the figures, data types, field names, and outlines are indicated per field (item) included in each message. Since the details of each field are described in the specification of each protocol, description thereof will be omitted here.

As illustrated in the figures, the data type of each field that configures the header part of the OSD-based READ response message or the header part of the CIFS-based READ response message is determined in advance. The size of each field is determined depending on the data type. Accordingly, the header length of each message can be calculated by summing up the sizes of fields included in each header part.

Then, the filter unit 13 compares a header length A of the OSD-based READ response message with a header length B of the CIFS-based READ response message (S204). When the header length A is longer than or equal to the header length B (Yes at S204), the filter unit 13 determines whether a difference α between the header length A and the header length B (the header length A—the heard length B) is an integral multiple of the maximum alignment boundary value (S205).

When the difference α is an integral multiple of the maximum alignment boundary value (Yes at S205), the filter unit 13 generates the header part of the CIFS-based READ response message on the basis of the header part of the OSD-based READ response message (S206). Then, the filter unit 13 copies the header part of the CIFS-based READ response message by writing it over the OSD-based READ response message (S207). At this time, the filter unit 13 overwrites the header part such that a position which is shifted behind from a starting address of the OSD-based READ response message by the difference α matches a starting address of the header part of the CIFS-based READ response message. Incidentally, the starting address of the OSD-based READ response message is synonymous with the starting address of the receive buffer.

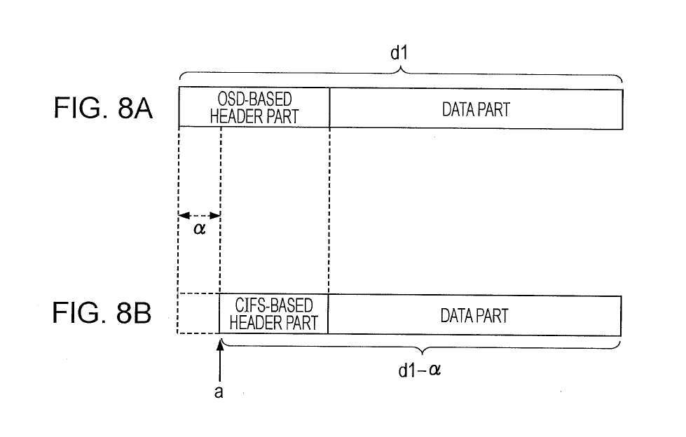

FIG. 8A and FIG. 8B are diagrams illustrating examples of copying of the header part of a CIFS-based READ response message by writing it over an OSD-based READ response message.

FIG. 8A indicates the contents (that is, an OSD-based READ response message) of a receive buffer before overwritten. In the example in FIG. 8A, the data size of the OSD-based READ response message is supposed to be d1.

FIG. 8B indicates the contents of the receive buffer after the header part (a CIFS header part) of the CIFS-based READ response message has been written over. In FIG. 8B, the CIFS header part is written over in a state in which it is shifted behind by the difference α between the header length A and the header length B. As a result, the CIFS header part and the data part are arranged in succession. In FIG. 8B, a part starting from an address a, which is shifted behind from the head of the receive buffer by the difference α, corresponds to the CIFS-based READ response message. Therefore, in the figure, the data size of the CIFS-based READ response message is d1-α.

Then, the filter unit 13 notifies the file operation protocol control unit 12 of the starting address (the address a) and the data size (d1-α) of the CIFS-based READ response message (S208). The file operation protocol control unit 12 makes a response to the client unit 11 on the basis of the CIFS-based READ response message which is specified by the starting address and the data size.

As described above, according to the embodiment, a new buffer is not prepared for a CIFS-based READ response message but the CIFS-based READ response is generated by writing the CIFS header part over the receive buffer of the OSD-based READ response message. Therefore, the number of memory-copying operations may be reduced and the activity ratio of the CPU may be maintained low. Such an effect as mentioned above may be more desirably exhibited as the number of accesses to the files increases.

In addition, a displacement of the starting address of the CIFS-based READ response message is an integral multiple of a maximum alignment boundary value. That is, the displacement of the starting address meets requirements for the alignment boundaries relevant to a process between generating the CIFS-based READ response message on the basis of the OSD-based READ response message and notifying the file operation protocol control unit 12 of the CIFS-based READ response message. As a result, it may become possible to prevent the process from being invalidated when the CIFS header part is copied or when the file operation protocol control unit 12 is notified of the starting address.

On the other hand, when the header length A is shorter than the header length B (No at S204), writing of the CIFS header part over the OSD-based READ response message is not allowed. Likewise, when the difference α is not an integral multiple of the maximum alignment boundary value (No at S205), it is not allowed to align the starting address of the CIFS header part on the alignment boundary. Therefore, in these cases, the filter unit 13 generates the CIFS header part as in the case at step S206 and notifies the file operation protocol control unit 12 of the starting address and the data size of the generated CIFS header part (S209). Then, the filter unit 13 notifies the file operation protocol control unit 12 of a starting address and a data size of the data part of the OSD-based READ response message (S210). The starting address which is notified of at step S210 has a value shifted from the starting address of the OSD-based READ response message behind by the header length A. In addition, the data size which is notified of at step S210 has a value obtained by subtracting the header length A from the length of the OSD-based READ response message. However, the size of the data part may be specified on the basis of a len field (see FIG. 7A) of the header part of the OSD-based READ response message.

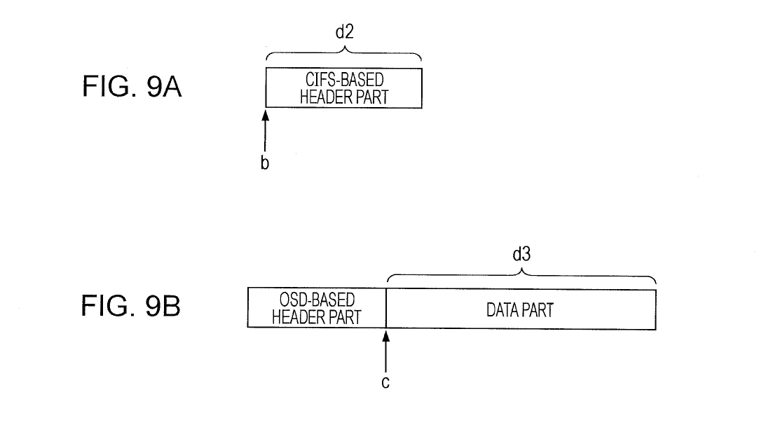

FIG. 9A and FIG. 9B are diagrams illustrating an example of data processing executed when writing of the header part of a CIFS-based READ response message over an OSD-based READ response message is not allowed.

FIG. 9A corresponds to step S209. That is, the file operation protocol control unit 12 is notified of a starting address b and a data size d2 of a CIFS header part which has been generated in a memory area other than the receive buffer. FIG. 9B corresponds to step S210. That is, the file operation protocol control unit 12 is notified of a starting address c and a data size d3 of the data part of an OSD-based READ response message within the receive buffer.

Incidentally, when an OSD-based WRITE response message is received, execution of a complicated process as illustrated in FIG. 6 is not needed, because the WRITE response message includes no data part. In this case, the filter unit 13 generates a CIFS header part on the basis of the header part of the received OSD-based WRITE response message. The filter 13 notifies the file operation protocol control unit 12 of the starting address and the data size of the generated CIFS header part.

As described above, according to the embodiment, a CIFS-based request message is intercepted by the filter unit 13 and a request for operating a file subjected to operation is transferred to the storage server 30 indicated by the arrangement information of the file subjected to the operation. Therefore, it may become possible to cope with distributed management of files while avoiding alteration of existing parts such as the file operation protocol control unit 12 and the communication control unit 14.

In addition, the filter unit 13 also executes protocol conversion between the CIFS protocol and the OSD protocol. As a result, distributed management of files may be performed by utilizing a storage server 30 that supports a protocol, which is not supported by the file operation protocol control unit 12.

Incidentally, the CIFS protocol and the OSD protocol are only examples. The protocol illustrated in the embodiment may be replaced with another remote file management protocol such as the NFS (Network File System) protocol.

In addition, the protocol that the file operation protocol control unit 12 uses may be the same as the protocol that the filter unit 13 uses. For example, both the arrangement information management apparatus 20 and the storage server 30 may be CIFS servers. In this case, a protocol converting process executed by the filter unit 13 may be eliminated.

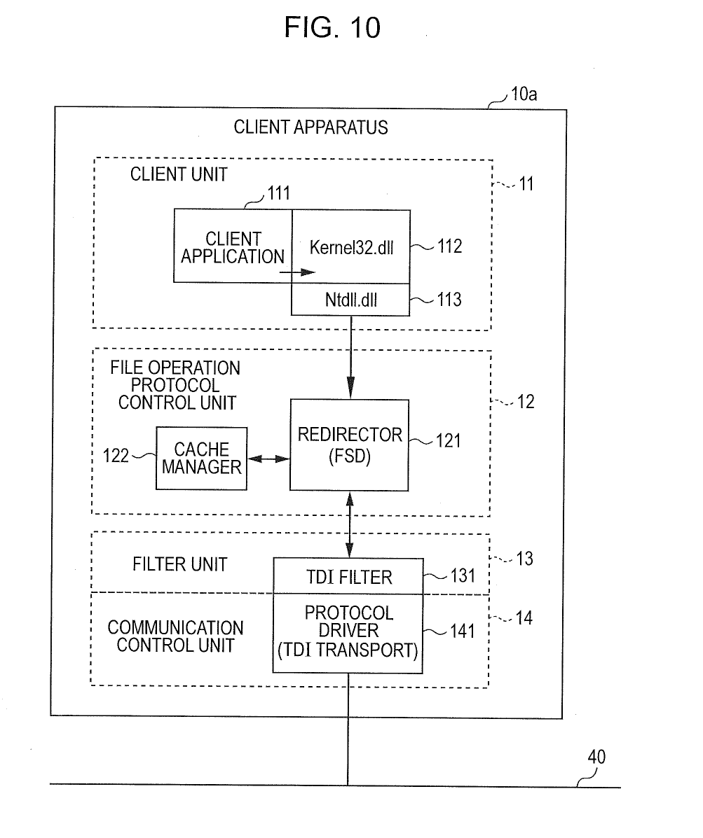

FIG. 10 illustrates an example in which the embodiment is applied to a specific implementing system. FIG. 10 is a diagram illustrating an example of a configuration of a client apparatus configured by applying the embodiment to a specific implementing system.

FIG. 10 illustrates an example in which the embodiment is applied to a mechanism of a remote FSD (File System Driver) which is adopted in Windows (registered trademark).

In a client apparatus 10a illustrated in FIG. 10, a client application 111, a Kernel32.d11 112, and an Ntdll.dll 113 are included in the client unit 11. In addition, a file system driver (FSD) called a redirector 121 and a cache manager 122 are included in the file operation protocol control unit 12. A TDI filter 131 corresponds to the filter unit 13. Additionally, a protocol driver 141 corresponds to the communication control unit 14.

The client application 111 is an arbitrary application program serving as a file operating request source. The client application 111 calls a function included in the Kernel32.d11 112 to input a file operating request. The file operating request is input into the redirector 121 via the Ntdll.dll 113. In general, a CIFS-based request message that the redirector 121 generates and transmits via the protocol driver 141 is intercepted by the TDI filter 131. The TDI filter 131 executes procedures of the process which has been described with reference to FIG. 4 to convert the CIFS-based request message to an OSD-based request message and causes the protocol driver 141 to execute transmission of the OSD-based request message.

When the protocol driver 141 receives a response for the OSD-based request message, the TDI filter 131 executes procedures of the process which has been described with reference to FIG. 6.

Incidentally, the TDI filter 131 is preferably implemented as a filter driver in a Windows (registered trademark) environment.

In the example illustrated in FIG. 10, it is allowed to incorporate the TDI filter 131 into the apparatus without modifying parts other than the TDI filter 131. As a result, it may become possible to configure the client apparatus 10a to cope with distributed management of files while avoiding alteration of existing parts (the kernel of an OS and the like).

According to the above embodiments, it may become possible to realize distributed management of files in a file management system while avoiding a change in the source code of an existing part.

Although the embodiments of the invention have been described in detail, the invention is not limited to such specific embodiments as mentioned above and may be varied and altered in a variety of ways within the scope of the gist of the invention defined in claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distributed file operation method executed by a computer that is connected to an arrangement information management apparatus and a plurality of file management apparatuses through a network, the arrangement information management apparatus being configured to manage arrangement information of files, the plurality of file management apparatuses being configured to store the files, the distributed file operation method comprising:
generating an operating request on a first file on the basis of a first protocol;
making, by the computer, an inquiry to the arrangement information management apparatus on arrangement information of the first file by specifying an identifier of the first file; and
transmitting the operating request to one of the plurality of file management apparatuses indicated by the arrangement information that is provided in response to the inquiry by the arrangement information management apparatus.

2. The distributed file operation method according to claim 1, further comprising:
converting, by the computer, the operating request from a first format generated on the basis of the first format to a second format generated on the basis of a second protocol;
wherein the transmitting includes transmitting the converted operating request to the one of the plurality of file management apparatuses.

3. The distributed file operation method according to claim 2, further comprising:
receiving a response of the second format from the one of the plurality of file management apparatuses, the response including a first header of the second format and data that is read out from the first file in response to the operating request; and
writing a second header of the first format over the first header of the response.

4. The distributed file operation method according to claim 3,
wherein the second header is written over the first header so that a starting address of the second header matches a position that is shifted behind from a starting address of the first header by a difference between a length of the first header and a length of the second header.

5. A distributed file operation apparatus configured to be connected to an arrangement information management apparatus and a plurality of file management apparatuses through a network, the arrangement information management apparatus being configured to manage arrangement information of files, the plurality of file management apparatuses being configured to store the files, the distributed file operation apparatus comprising
a processor configured to perform a process including:
generating an operating request on a first file on the basis of a first protocol,
making an inquiry to the arrangement information management apparatus on arrangement information of the first file by specifying an identifier of the first file, and
transmitting the operating request to one of the plurality of file management apparatuses indicated by the arrangement information that is provided in response to the inquiry by the arrangement information management apparatus.

6. The distributed file operation apparatus according to claim 5,
wherein the process further includes:
converting the operating request from a first format generated on the basis of the first format to a second format generated on the basis of a second protocol, and
transmitting the converted operating request to the one of the plurality of file management apparatuses.

7. The distributed file operation apparatus according to claim 6,
wherein the process further includes:
receiving a response of the second format from the one of the plurality of file management apparatuses, the response including a first header of the second format and data that is read out from the first file in response to the operating request, and
writing a second header of the first format over the first header of the response.

8. The distributed file operation apparatus according to claim 7,
wherein the process further includes:
writing the second header over the first header so that a starting address of the second header is matches a position that is shifted behind from a starting address of the first header by a difference between a length of the first header and a length of the second header.

9. A non-transitory computer-readable medium that stores therein a distributed file operation program causing a computer to execute a distributed file operation process, the computer being connected to an arrangement information management apparatus and a plurality of file management apparatuses through a network, the arrangement information management apparatus being configured to manage arrangement information of files, the plurality of file management apparatuses being configured to store the file, the distributed file operation process comprising:
generating an operating request on a first file on the basis of a first protocol;
making an inquiry to the arrangement information management apparatus on arrangement information of the first file by specifying an identifier of the first file; and
transmitting the operating request to one of the plurality of file management apparatuses indicated by the arrangement information that is provided in response to the inquiry by the arrangement information management apparatus.

10. The non-transitory computer-readable medium according to claim 9, wherein the distributed file operation process further comprises:
converting the operating request to an operating request of a second-protocol-based format,
wherein the transmitting includes transmitting the converted operating request to the file management device indicated by the arrangement information.

11. The non-transitory computer-readable medium according to claim 10, wherein the distributed file operation process further comprises:
receiving a response of the second format from the one of the plurality of file management apparatuses, the response including a first header of the second format and data that is read out from the first file in response to the operating request; and
writing a second header of the first format over the first header of the response.

12. The non-transitory computer-readable medium according to claim 11, wherein the second header is written over the first header so that a starting address of the second header matches at a position that is shifted behind from a starting address of the first header by a difference between a length of the first header and a length of the second header.
